(19) United States
(12) Patent Application Publication
(10) Pub. No.: US 2016/0325683 A1
(43) Pub. Date: Nov. 10, 2016

(54) VIRTUAL IMAGE DISPLAY DEVICE, HEAD-UP DISPLAY SYSTEM, AND VEHICLE

(71) Applicant: Panasonic Intellectual Property Management Co., Ltd., Osaka (JP)

(72) Inventor: Katsuhiko HAYASHI, Nara (JP)

(21) Appl. No.: 15/212,647

(22) Filed: Jul. 18, 2016

Related U.S. Application Data
(63) Continuation of application No. PCT/JP2015/000455, filed on Feb. 3, 2015.

(30) Foreign Application Priority Data
Mar. 26, 2014 (JP) 2014-063495

(51) Int. Cl. B60R 1/00; G02B 27/22; G06K 9/00; G02B 27/01; B60K 35/00; G06F 3/01

(52) U.S. Cl. CPC B60R 1/00; B60K 35/00; G06F 3/013; G06K 9/00604; G02B 27/0101; G02B 27/0179; G02B 27/2214; B60R 2300/205; G02B 2027/0145; G02B 2027/0134; G02B 2027/0187; G02B 2027/0129

(57) ABSTRACT

An object of the present disclosure is to provide a virtual image display device which improves convenience by supporting fusion. The virtual image display device according to the present disclosure includes: a display device which outputs a parallax image; an optical system which displays a virtual image based on the parallax image; an obtaining unit which obtains a change of a point of gaze of an observer; and a controller which, when obtaining from the obtaining unit a change of the point of gaze of the observer from a first point of gaze to a second point of gaze, controls the display device to generate at least one intermediate parallax image between a parallax image corresponding to the first point of gaze and a parallax image corresponding to the second point of gaze.

### BACKGROUND

1. Technical Field

The present disclosure relates to a virtual image display device, a head-up display system which includes the virtual image display device, and a vehicle on which the head-up display system is mounted.

2. Description of Related Art

A virtual image display device such as a head-up display (HUD) superimposes an image in which assist information for assisting driving is drawn, as a virtual image on a foreground of a driver who rides in a vehicle such as a car, and displays the image. Unexamined Japanese Patent Publication No. 2005-301144 discloses a virtual image display device which changes a display distance of a virtual image by changing a parallax amount of a left eye virtual image and a right eye virtual image, having left and right eyes view the virtual images and fusing the virtual images.

### SUMMARY

Fusion is realized by movement of eyeballs or a function of a visual center. Hence, the time required to realize fusion varies between individuals. Under a situation that a driver driving a vehicle needs to pay a great amount of attention, the more time required to realize fusion, the less preferable from a point of view of safety.

An object of the present disclosure is to provide a virtual image display device, a head-up display system and a vehicle which improve convenience by supporting fusion.

The virtual image display device according to the present disclosure includes: a display device which outputs a parallax image; an optical system which displays a virtual image based on the parallax image; an obtaining unit which obtains a change of a point of gaze of an observer; and a controller which, when obtaining from the obtaining unit a change of the point of gaze of the observer from a first point of gaze to a second point of gaze, controls the display device to generate at least one intermediate parallax image between a parallax image corresponding to the first point of gaze and a parallax image corresponding to the second point of gaze.

The present disclosure can provide a virtual image display device, a head-up display system and a vehicle which improve convenience by supporting fusion.

### BRIEF DESCRIPTION OF DRAWINGS

FIG. 1 is a view illustrating a configuration of a head-up display system according to a first exemplary embodiment.

FIG. 2 is a block diagram illustrating a configuration of a display device, parallax barriers, a controller and an imaging device according to the first exemplary embodiment.

FIG. 3 is a view illustrating a relationship between a left eye image, a right eye image and a stereoscopic image for an observer according to the first exemplary embodiment.

FIG. 4 is a view for explaining a parallax amount when a point of gaze of the observer changes from a close point to a far point.

FIG. 5 is a view for explaining a parallax amount when a point of gaze of the observer changes from the far point to the close point.

FIG. 6 is a flowchart illustrating an operation of the head-up display system according to the first exemplary embodiment.

FIG. 7 is a view illustrating a configuration of a head-up display system according to a second exemplary embodiment.

FIG. 8 is a flowchart illustrating an operation of the head-up display system according to the second exemplary embodiment.

### DESCRIPTION OF EMBODIMENTS

Exemplary embodiments will be described in detail below optionally with reference to the drawings. In this regard, detailed explanation will not be made more than necessary in some cases. For example, detailed explanation of well-known matters and overlapping explanation of substantially same components will not be described in some cases. This is to prevent the following explanation from unnecessarily becoming redundant and facilitate understanding of those skilled in the art.

In addition, the accompanying drawings and the following description are provided to help those skilled in the art sufficiently understand the present disclosure, and do not intend to limit the subject matter recited in the claims

### First Exemplary Embodiment

### [1-1. Configuration of Head-Up Display System]

The head-up display system according to the present disclosure is equipped at, for example, a driver's seat of a car. The configuration of the head-up display system will be described.

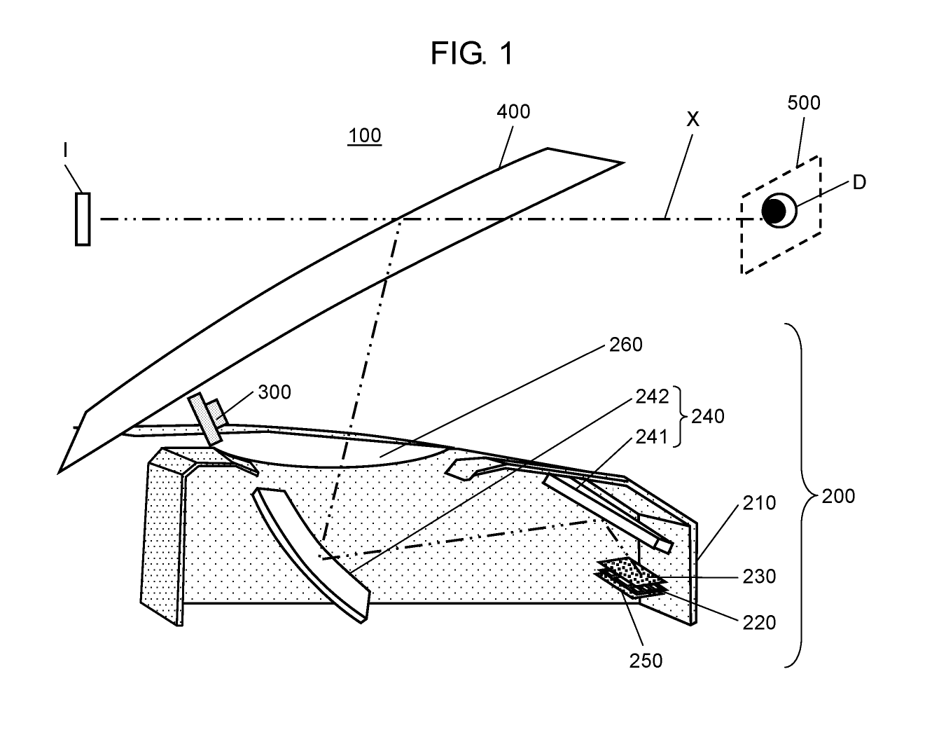

FIG. 1 is a view illustrating a configuration of head-up display system 100 according to the first exemplary embodiment. Head-up display system 100 has virtual image display device 200, imaging device 300 and wind shield 400.

Virtual image display device 200 includes housing 210, and includes display device 220, parallax barriers 230, mirror 240 composed of first mirror 241 and second mirror 242, and controller 250 such as a microcomputer inside housing 210. Further, housing 210 includes aperture 260. Aperture 260 may be covered by a transparent cover.

Virtual image display device 200 is disposed inside a dashboard of a car, for example. Virtual image I is displayed by reflecting at first mirror 241 an image displayed by display device 220, further reflecting the image at second mirror 242, further reflecting the image at wind shield 400 and guiding the image to observer D inside the vehicle.

For display device 220, a liquid crystal display, an organic EL (Electroluminescence) display or a plasma display is used. Display device 220 displays various pieces of information such as a road guidance, a distance to a front vehicle, a remaining battery of a car and a current car speed. First mirror 241 is provided at an upper part of display device 220 in the vertical direction, and has a reflection plane directed toward a second mirror direction.

In addition, mirror 240 may not be provided, and an image outputted from display device 220 may be directly projected to wind shield 400 through aperture 260.

Imaging device 300 is a camera which captures an image of point-of-view region 500 of observer D inside the car. Imaging device 300 supplies the captured image to controller 250. Controller 250 detects a position of a point of gaze by observer D by analyzing the supplied captured image. In this regard, the position of the point of gaze refers to a front position which observer D gazes over wind shield 400. The position of the point of gaze is grasped as a distance from observer D. Controller 250 can derive a congestion point and detect a position of point of gaze X by analyzing eye directions of both eyes of observer D.

In addition, detection of the point of gaze is not limited to this, and another method may be adopted as long as the method can detect a position of a point of gaze of observer D.

Wind shield 400 is a shield which is provided to protect observer D inside the car from a flow of air coming from the front while the car is being driven. Wind shield 400 is made of, for example, glass.

In the present exemplary embodiment, a case where wind shield 400 is used will be described. However, the present disclosure is not limited to this. A combiner may be used instead of wind shield 400.

### [1-2. Configuration of Display Device and Parallax Barriers]

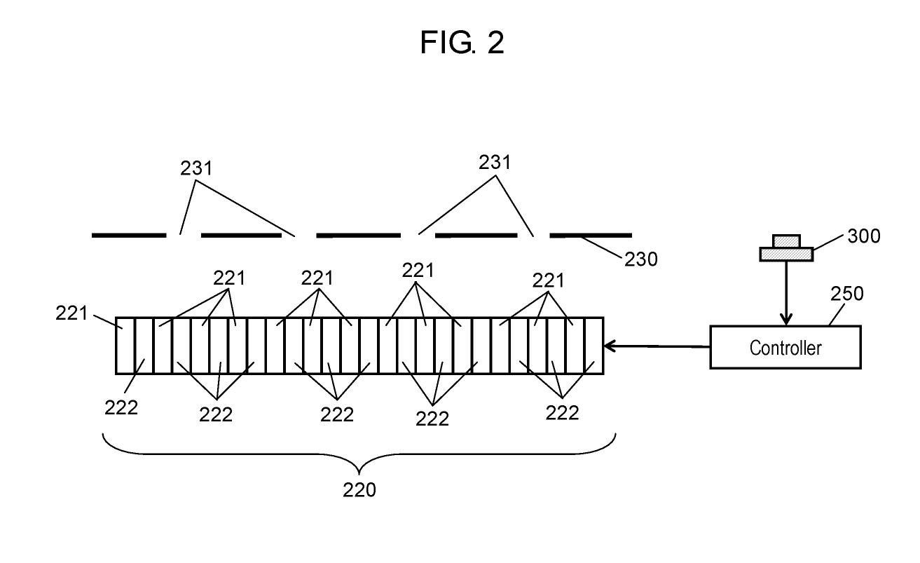

Next, the configuration of display device 220 and parallax barriers 230 will be described in detail. FIG. 2 is a configuration diagram of display device 220, parallax barriers 230, controller 250 and imaging device 300. Parallax barriers 230 are formed by depositing a light shielding material such as chrome on a glass substrate which is not illustrated, and one-dimensionally forming the light shielding material in a stripe shape on the glass substrate. Portions at which the light shielding material is not deposited are apertures 231.

Display device 220 includes R (RED), G (Green) and B (Blue) pixels.

In the first exemplary embodiment, pixels of display device 220 are spatially divided into left eye pixels 221 and right eye pixels 222. That is, the pixels of display device 220 are alternately allocated as left eye pixels 221 and right eye pixels 222.

Controller 250 detects a point of gaze of observer D by analyzing an image captured by imaging device 300, and controls a display image of display device 220 based on the detected point of gaze. Display device 220 outputs the display image under control of controller 250.

Parallax barriers 230 include apertures 231 formed at predetermined intervals. Apertures 231 control distribution of light beams emitted from display device 220. Light beams emitted from left eye pixels 221 arrive at the left eye of observer D, and light beams emitted from right eye pixels 222 arrive at the right eye of observer D. Consequently, display device 220 and parallax barriers 230 can present an image having a parallax to observer D.

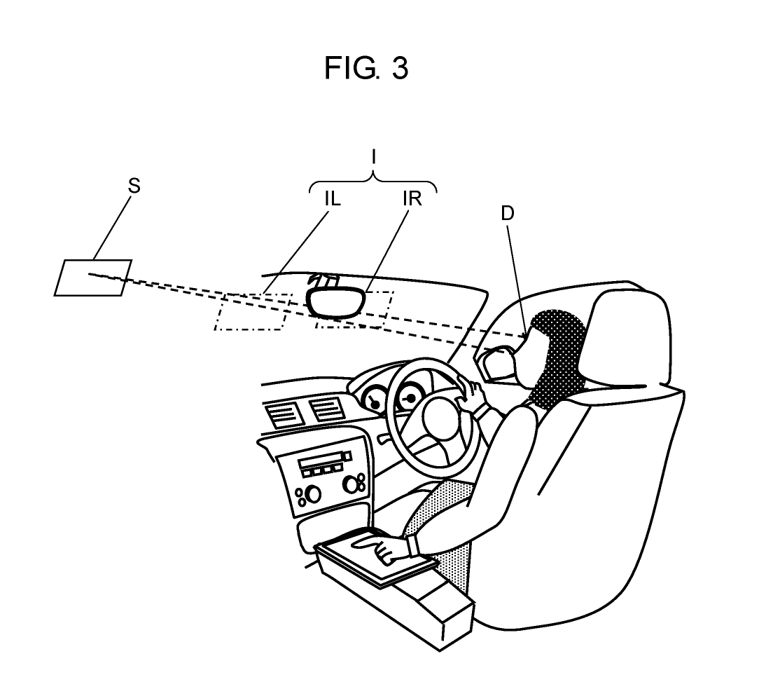

FIG. 3 is a view illustrating a relationship between left eye virtual image IL, right eye virtual image IR and stereoscopic image S for observer D. When observer D uses head-up display system 100, left eye virtual image IL and right eye virtual image IR which are virtual image I of parallax images are displayed at predetermined positions. When viewing left eye virtual image IL and right eye virtual image IR, observer D perceives that stereoscopic image S obtained by stereoscopically viewing and fusing the virtual images is far from the predetermined positions.

In this regard, the predetermined positions at which left eye virtual image IL and right eye virtual image IR which are virtual image I are displayed are defined as “reference virtual image positions”.

Generally, a point of gaze of observer D and the reference virtual image positions are different. When a distance between the point of gaze and the reference virtual image positions is long, congestion angles of virtual images displayed at arbitrary positions are different from congestion angles of virtual images displayed at reference virtual image positions. Therefore, a stereoscopic image becomes double, and visibility deteriorates.

In this regard, a relationship between parallax amount Q which is added to a display image of display device 220, and stereoscopic view distance L which is a distance from observer D to a fusion position at which a fused image is perceived is expressed by (Mathematical equation 1).

$$Q = \frac{( L - LI ) S}{L} \qquad [ Mathematical equation 1 ]$$

where
Q: Parallax amount of right eye virtual image and left eye virtual image
L: Distance from observer D to fusion position
LI: Distance from observer D to reference virtual image position
S: Interval between right eye and left eye of observer D

By changing parallax amount Q of right eye virtual image IR and left eye virtual image IL, controller 250 can change congestion angle 0 according to parallax amount Q, and change a display distance of virtual image I which is displayed to observer D.

Fusion in this case includes that, when lines which individually connect right and left eye positions of observer D and right and left parallax images, respectively are drawn, an intersection of the lines includes a point of gaze. Further, the fusion also includes that a congestion angle formed when the right and left eyes independently view the right and left parallax images, respectively, and congestion angles formed at a point of gaze match.

In addition, display device 220 outputs a left eye image and a right eye image by way of spatial division. However, the present disclosure is not limited to this. Display device 220 may sequentially output a left eye image and a right eye image by way of time division.

In addition, use of parallax barriers 230 has been described above. However, the present disclosure is not limited to this. Another component such as a lenticular lens or a liquid crystal lens may be used as long as another component can control distribution of light beams projected from display device 220.

### [1-3. Operation]

Next, the operation of head-up display system 100 will be described.

In the present exemplary embodiment, a fusion assist operation in case where observer D moves a point of view from a first point of gaze to a second point of gaze will be described. Movement of the point of view occurs in response to a change in driving environment of observer D such as a change in a speed, a change of a scene seen from a car window, a change in environment outside the car and a change in navigation.

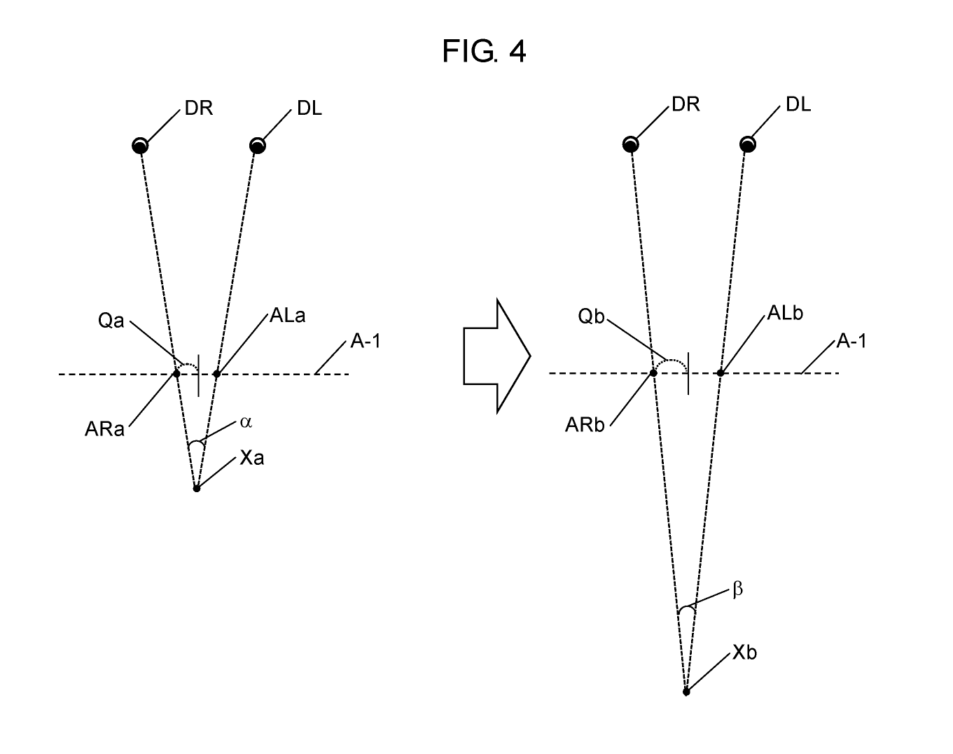

FIG. 4 is a view for explaining a parallax amount when a point of gaze of observer D changes from a close point to a far point. In FIG. 4, a left side view illustrates that a point of view of observer D is at first point of gaze Xa, and a right side view illustrates that the point of view of observer D is at second point of gaze Xb. In FIG. 4, when the point of view of observer D is at first point of gaze Xa, an intersection of a line connecting right eye DR of observer D and first point of gaze Xa, and reference virtual image position A-1 is ARa, and an intersection of a line connecting left eye DL of observer D and first point of gaze Xa, and reference virtual image position A-1 is ALa, and a parallax amount of first point of gaze Xa is Qa. Further, in FIG. 4, when the point of view of observer D is at second point of gaze Xb, an intersection of a line connecting right eye DR of observer D and second point of gaze Xb, and reference virtual image position A-1 is ARb, and an intersection of a line connecting left eye DL of observer D and second point of gaze Xb, and reference virtual image position A-1 is ALb, and a parallax amount of second point of gaze Xb is Qb.

As illustrated in FIG. 4, when the point of view of observer D is at first point of gaze Xa, virtual image I of parallax images is displayed at reference virtual image position A-1. That is, right eye virtual image IR is displayed at ARa, and left eye virtual image IL is displayed at ALa.

Next, the point of view of observer D moves from first point of gaze Xa to second point of gaze Xb. In this case, virtual image I of the parallax images is displayed at reference virtual image position A-1. That is, right eye virtual image IR is displayed at ARb, and left eye parallax virtual image IL is displayed at ALb.

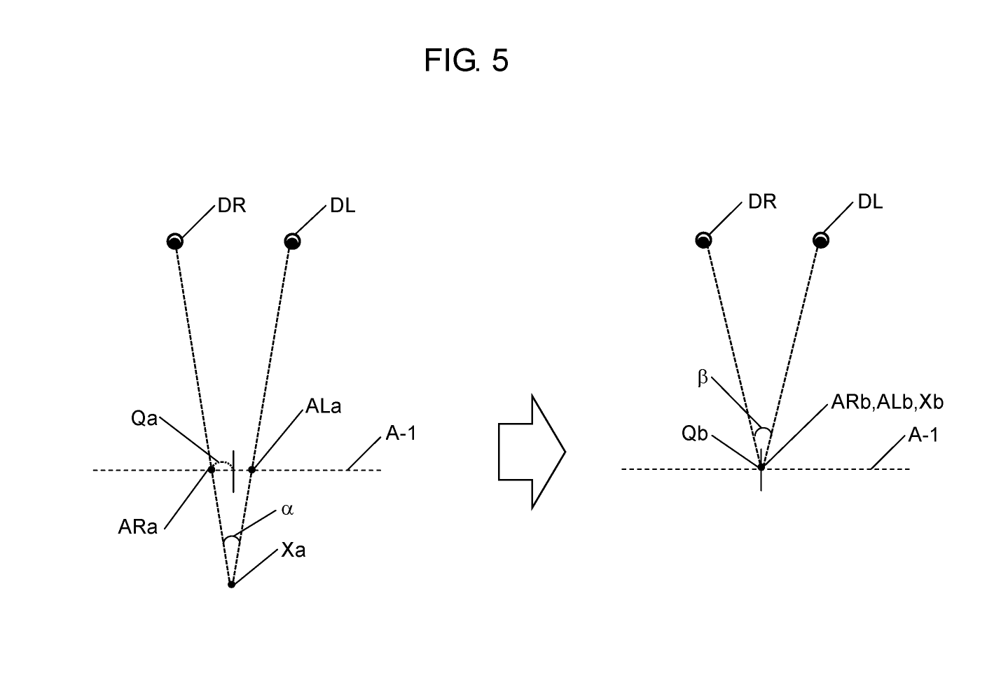

FIG. 5 is a view for explaining a parallax amount when a point of gaze of observer D changes from a far point to a close point. In FIG. 5, a left side view illustrates that a point of view of observer D is at first point of gaze Xa, and a right side view illustrates that the point of view of observer D is at second point of gaze Xb. In FIG. 5, when the point of view of observer D is at first point of gaze Xa, an intersection of a line connecting right eye DR of observer D and first point of gaze Xa, and reference virtual image position A-1 is ARa, and an intersection of a line connecting left eye DL of observer D and first point of gaze Xa, and reference virtual image position A-1 is ALa. Further, in FIG. 5, when the point of view of observer D is at second point of gaze Xb, an intersection of a line connecting right eye DR of observer D and second point of gaze Xb, and reference virtual image position A-1 is ARb, and an intersection of a line connecting left eye DL of observer D and second point of gaze Xb, and reference virtual image position A-1 is ALb.

As illustrated in FIG. 5, when the point of view of observer D is at first point of gaze Xa, virtual image I of parallax images is displayed at reference virtual image position A-1. That is, right eye virtual image IR is displayed at ARa, and left eye virtual image IL is displayed at ALa.

Head-up display system 100 adjusts a parallax amount of a display image to fuse at a position of the point of gaze of observer D. In this regard, movement of the point of gaze involves movement in a horizontal direction with respect to a traveling direction. However, this movement mainly refers to movement in a front-back direction of observer D. When a position of the first point of gaze matches with a reference virtual image position, an output image of display device 220 does not need to be a parallax image. However, when the position of the first point of gaze does not match with the reference virtual image position, display device 220 displays a parallax image.

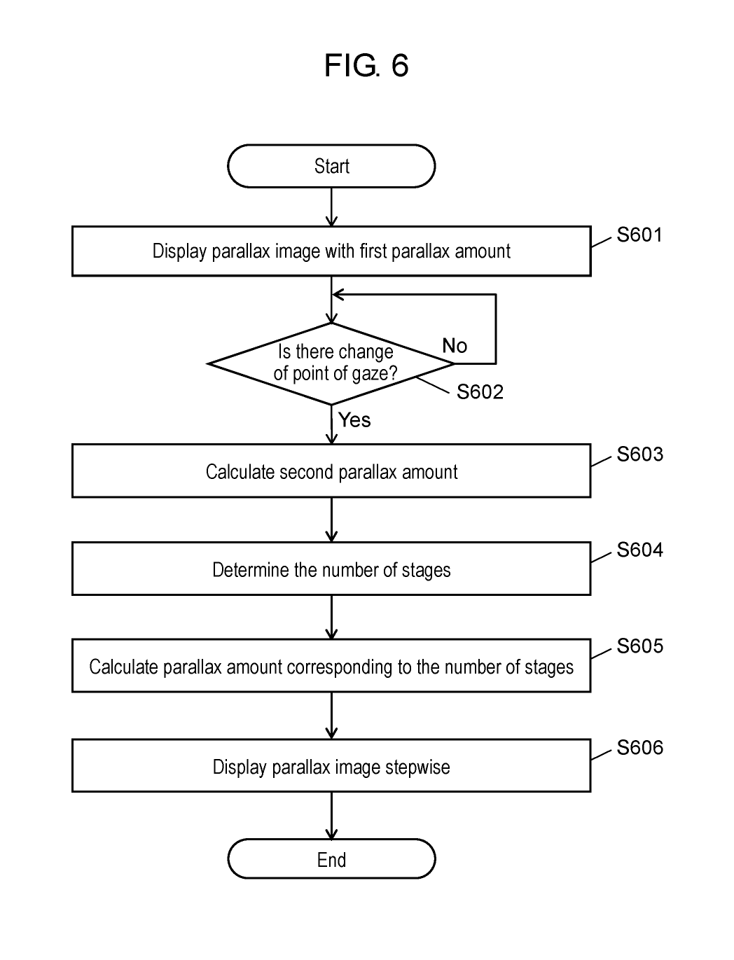

FIG. 6 is a flowchart illustrating an operation of head-up display system 100 according to the first exemplary embodiment.

(S601) Position information of a point of gaze is obtained and calculated when imaging device 300 captures an image of point-of-view region 500 of observer D. Controller 250 calculates first parallax amount Qa for fusing the position information of the point of gaze at first point of gaze Xa by using (Mathematical equation 1). Further, controller 250 generates a parallax image based on calculated first parallax amount Qa, and causes display device 220 to display the parallax image.

(S602) Whether or not the point of gaze of observer D changes, i.e., whether or not the point of gaze has moved from first point of gaze Xa to second point of gaze Xb is determined. This determination is made by causing imaging device 300 to detect a change of point-of-view region 500 of observer D. When there is no change in the point of gaze of observer D (in case of No), the flow returns to S602. When there is a change in the point of gaze of observer D (in case of yes), the flow proceeds to S603.

(S603) Controller 250 obtains position information of second point of gaze Xb from imaging device 300, and calculates second parallax amount Qb for fusing position information of second point of gaze Xb at second point of gaze Xb by using (Mathematical equation 1).

(S604) Subsequently, controller 250 calculates difference ΔQ between first parallax amount Qa and second parallax amount Qb, and determines number of stages n (n is a natural number equal to or more than 1) of intermediate parallax images provided between a parallax image of first parallax amount Qa and a parallax image of second parallax amount Qb based on calculated difference ΔQ. When, for example, movement of a point of view from first point of gaze Xa to second point of gaze Xb is 0.9 degrees as an angular change amount of a congestion angle, the number of stages is three.

(S605) When the angular change amount is 0.9 degrees and the number of stages is three, for example, the angular change amount is 0.3 degrees at the first stage, the angular change amount is 0.6 degrees at the second stage and the angular speed change amount is 0.9 degrees at the third stage, i.e., second point of gaze Xb. Controller 250 calculates a parallax amount corresponding to these angular change amounts.

(S606) Controller 250 generates a parallax image based on the calculated parallax amount, and causes display device 220 to display the parallax image. Parallax images are continuously displayed in order of a parallax image corresponding to first point of gaze Xa, a parallax image corresponding to a parallax amount of 0.3 degrees as the angular change amount, a parallax image corresponding to a parallax amount of 0.6 degrees as the angular change amount and a parallax image corresponding to second point of gaze Xb. Further, by viewing these parallax images displayed at the reference virtual image positions, observer D can view that stereoscopic image S obtained by stereoscopically viewing these parallax images gradually moves from the first point of gaze to the second point of gaze.

### [1-4. Effect and Others]

As described above, when observer D moves a line of sight from first point of gaze Xa to second point of gaze Xb and then stereoscopically views a virtual image of parallax images generated stepwise, head-up display system 100 according to the present disclosure can assist observer D to move the point of view from a stereoscopic image fused at first point of gaze Xa to a stereoscopic image fused at second point of gaze Xb. That is, when moving a point of view, observer D can more comfortably move a point of view with respect to a stereoscopic view compared to when a parallax image corresponding to first point of gaze Xa is directly switched to a parallax image corresponding to second point of gaze Xb to display.

In this regard, “3D consortium” which has been established for a purpose of developing and spreading 3D stereoscopic display devices and expanding 3D content designates “3DC Safety Guidelines for Dissemination of Human-friendly 3D revised on Apr. 20, 2010”. As a comfortable parallax range, this guideline recommends a congestion angle of about 2 degrees when there are an unspecified number of targets, and a congestion angle of 1 degree or less according to conventional studies and empirical rules. However, even when a change amount of a congestion angle caused by movement of a point of gaze is 1 degree or less, and a less parallax amount and a less change amount of the parallax amount make stereoscopic viewing easier. Consequently, generating intermediate parallax images to which intermediate parallax amounts are added is effective for movement of a point of view for stereoscopic viewing.

In addition, as illustrated in FIGS. 4 and 5, intermediate parallax images may be generated and inserted by adding parallax amounts of Δθ/n at a time in response to change Δθ of a congestion angle according to number of stages n when congestion angle α changes to congestion angle β. Further, an addition amount may not be an equal amount, either.

In addition, when a point of gaze of observer D and reference virtual image positions match, display device 220 may not output parallax images.

In addition, a speed for changing a parallax amount or at what number of stages the parallax amount is changed may be statistically found based on an age of observer D or the like, or may be optionally corrected based on an imaging result of imaging device 300. Further, when a change amount of a parallax amount is greater, the number of stages may be increased.

### Second Exemplary Embodiment

### [2-1. Configuration of Head-Up Display System]

Next, the head-up display system according to the second exemplary embodiment will be described. In the present exemplary embodiment, a difference of components of the head-up display system from those of the first exemplary embodiment will be mainly described.

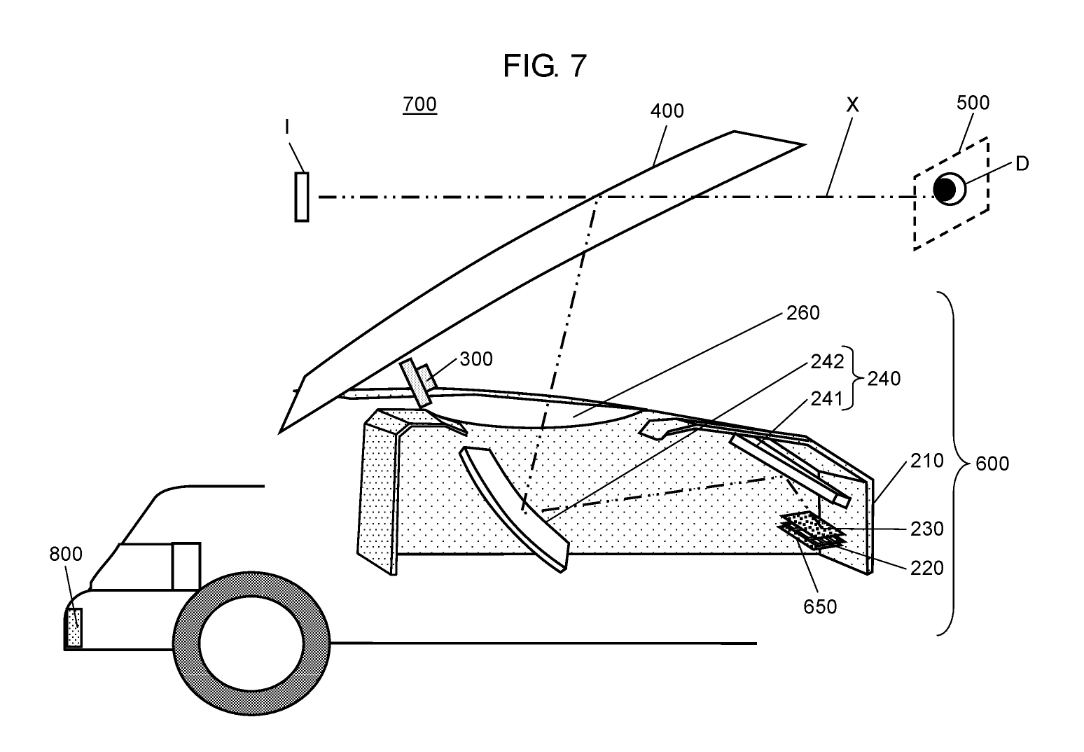

FIG. 7 is a view illustrating a configuration of head-up display system 700 according to the second exemplary embodiment. Head-up display system 700 has virtual image display device 600, imaging device 300, wind shield 400 and sensor device 800.

Imaging device 300 and wind shield 400 are the same components as those in the first exemplary embodiment, and therefore will not be described.

Virtual image display device 600 includes housing 210, and includes display device 220, parallax barriers 230, mirror 240 composed of first mirror 241 and second mirror 242, and controller 650 such as a microcomputer inside housing 210. Further, housing 210 includes aperture 260. Configurations of housing 210, display device 220, parallax barriers 230 and mirror 240 are the same as those in the first exemplary embodiment, and therefore will not be described.

Sensor device 800 is installed at a bumper or the like arranged at a front of a car, and detects an object such as a pedestrian or a bicycle which is in front of a car and enters a field of view of observer D from a left-right direction outside the field of view. Sensor device 800 supplies a detection result to controller 250. Further, controller 250 specifies the object by analyzing the supplied result.

### [2-2. Operation]

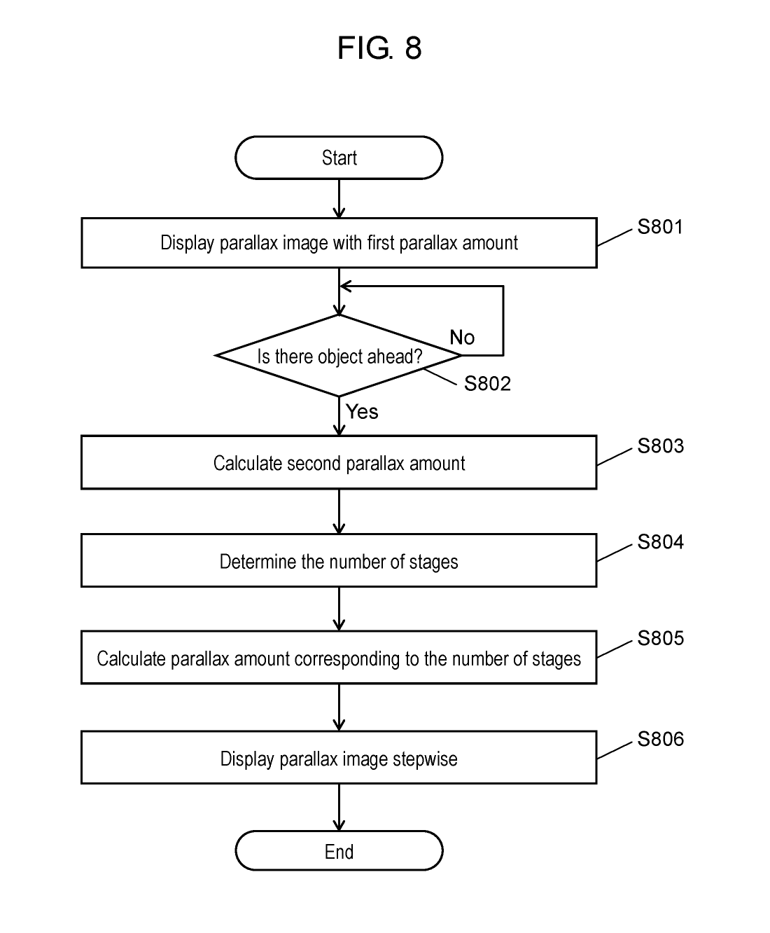

An operation of moving a point of gaze of observer D to a position of an object, i.e., an operation of moving the point of gaze of observer D from a first point of gaze to a second point of gaze which is a position of the object when an object such as a pedestrian or a bicycle which is in front of the car and enters a field of view of observer D from the right and left direction outside the field of view is detected will be described. FIG. 8 is a flowchart illustrating an operation of head-up display system 700 according to the second exemplary embodiment.

(S801) Similar to S601 in the first exemplary embodiment, controller 650 calculates a first parallax amount from the first point of gaze, generates a parallax image based on the calculated parallax amount and causes display device 220 to display the parallax image.

(S802) Whether or not there is an object in front of the car is determined. Controller 650 makes this determination by analyzing a result supplied from sensor device 800. When it is determined that there is not an object (in case of No), the flow returns to S802 and, when it is determined that there is an object (in case of Yes), the flow proceeds to S803.

(S803) Controller 650 obtains position information of an object based on a detection result of sensor device 800, and calculates a second parallax amount based on the obtained position information.

(S804) Controller 650 calculates a difference between the first parallax and the second parallax amount, and determines number of stages n (n is a natural number equal to or more than 1) of intermediate parallax images provided between a parallax image of the first parallax amount and a parallax image of the second parallax amount based on the calculated difference.

When, for example, movement of a point of view from the first point of gaze to the second point of gaze is 0.9 degrees as an angular change amount of a congestion angle, the number of stages is three.

(S805) When the angular change amount is 0.9 degrees and the number of stages is three, for example, the angular change amount is 0.3 degrees at the first stage, and the angular change amount is 0.6 degrees at the second stage. Controller 650 calculates a parallax amount corresponding to these angular change amounts.

(S806) Further, controller 650 generates a parallax image based on the calculated parallax amount, and causes display device 220 to display the parallax image. Parallax images are continuously displayed in order of a parallax image corresponding to the first point of gaze, a parallax image corresponding to a parallax amount of 0.3 degrees as the angular change amount, a parallax image corresponding to a parallax amount of 0.6 degrees as the angular change amount and a parallax image corresponding to the position of the object. Further, observer D can view virtual image I of the parallax images at the reference virtual image positions.

### [2-3. Effect and Others]

As described above, when observer D moves a point of gaze from the first point of gaze to the second point of gaze which is a position of an object and then stereoscopically views a virtual image of parallax images generated stepwise, head-up display system 700 according to the present disclosure can assist observer D to move the point of view from a stereoscopic image fused at the first point of gaze to a stereoscopic image fused at the position of the object. That is, when moving a point of view, observer D can more comfortably move a point of view with respect to a stereoscopic view compared to when a parallax image corresponding to the first point of gaze is directly switched to a parallax image corresponding to the point of gaze of the object to display.

The virtual image display device and the head-up display system which includes the virtual image display device according to the present disclosure are applicable not only for use in vehicles such as cars but also for use in pilots' seats of airplanes and ships, and simulation systems such as game machines which allow users to virtually experience operations.

1. A virtual image display device comprising:
a display device which outputs a parallax image;
an optical system which displays a virtual image based on the parallax image;
an obtaining unit which obtains a change of a point of gaze of an observer; and
a controller which, when obtaining from the obtaining unit a change of the point of gaze of the observer from a first point of gaze to a second point of gaze, controls the display device to generate at least one intermediate parallax image between a parallax image corresponding to the first point of gaze and a parallax image corresponding to the second point of gaze.

2. The virtual image display device according to claim 1, wherein the change of the point of gaze of the observer from the first point of gaze to the second point of gaze is movement of the point of gaze of the observer.

3. The virtual image display device according to claim 1, wherein the change of the point of gaze of the observer from the first point of gaze to the second point of gaze is such that the first point of gaze is the point of gaze of the observer and the second point of gaze is a position of an object which enters a field of view of the observer from an outside of the field of view.

4. The virtual image display device according to claim 1, wherein the controller determines a number of the intermediate parallax images to be generated, in accordance with a difference between the first point of gaze and the second point of gaze.

5. A head-up display system comprising the virtual display device according to claim 1.

6. A vehicle comprising the head-up display system according to claim 5, the head-up display system being mounted on the vehicle.
